(19) United States
(12) Patent Application Publication
(10) Pub. No.: US 2014/0074298 A1
(43) Pub. Date: Mar. 13, 2014

(54) Smart Recycling System

(71) Applicant: THE UNIVERSITY OF GEORGIA RESEARCH FOUNDATION, Athens, GA (US)

(72) Inventors: Jenna Jambeck, Athens, GA (US); Kyle Johnsen, Athens, GA (US); Eliana Mozo-Reyes, Athens, GA (US); Colby Sweet, Athens, GA (US)

(73) Assignee: THE UNIVERSITY OF GEORGIA RESEARCH FOUNDATION, Athens, GA (US)

(21) Appl. No.: 14/025,180

(22) Filed: Sep. 12, 2013

Related U.S. Application Data
(60) Provisional application No. 61/700,086, filed on Sep. 12, 2012.

(51) Int. Cl. G05B 15/02

(52) U.S. Cl. CPC G05B 15/02
USPC 700/275

(57) ABSTRACT

Disclosed are smart recycling system (“SRS”) solutions for retrofit to a recycling bin. Exemplary embodiments include a housing for mounting to a recycling bin or lid. The housing may include an integrated circuit and other components such as photoelectric sensors positioned to recognize a recycling event (e.g., deposit of an item into the bin). A signal indicative of a recycling event is generated and associated data stored. Positive and/or negative feedback may be rendered on a display component for the benefit of the user and in response to the recycling event. Some embodiments may be operable to intermittently power components within the system so that power consumption is minimized. Signals generated by sensors in some embodiments may be parsed to recognize deposit of recyclables as opposed to deposit of non-recyclables or false positive events (e.g., a hand inserted to trip the sensor).

### CROSS-REFERENCE TO RELATED APPLICATIONS

Priority under 35 U.S.C. §119(e) is claimed to the U.S. provisional application entitled “DISPOSAL BIN,” filed on Sep. 12, 2012 and assigned application Ser. No. 61/700,086, the entire contents of which are hereby incorporated by reference.

### BACKGROUND

The present invention relates to collection systems for recyclables and, more particularly, to a retrofittable smart recycling system for encouraging recycling and monitoring recycling activity. As is known in the prior art, “recycling bins” or other receptacles may be strategically located within a building, on a campus, around a municipality, etc. so that recyclable items may be placed within them in lieu of being discarded as trash. For example, certain items made of recyclable materials such as, but not limited to, paper, plastic, aluminum, etc. may be deposited in a recycling bin for later collection and transport to a recycling center.

Collection systems known in the art of recycling vary in complexity and cost. The most basic collection systems essentially consist of “trash cans” that have been designated for deposit of recyclables. The initial cost of a basic system may be manageable on even the slimmest of recycling program budgets, considering that initial investment is limited to the cost of the receptacles. Other, more technologically advanced collection systems, utilize integrated electronics and communication hardware to measure the level of recyclables deposited in a given recycling bin and report the measurements back to a central monitoring and data collection entity. Consequently, the initial cost of an advanced recycling system may represent a significant investment in proprietary receptacles and a central communication platform.

To date, users of collection systems have had to choose between the basic systems and the advanced systems. For the most part, entities without large budgets for establishing a recycling program have elected to invest in the basic systems with an intention of “revisiting” the cost/benefit analysis of the advanced systems once a culture of recycling is cultivated in their target recycling community. When it comes time to consider a migration to a more advanced recycling system, however, users of basic systems are inevitably faced with the reality that their initial investment in the basic system is a sunk cost. Therefore, what is needed in the art is a smart recycling system solution that may be retrofitted to an existing collection receptacle and networked back to a central monitoring and data collection entity. Additionally, what is needed in the art is a smart recycling system solution that leverages behavioral science to provide feedback at the point of recycling which may encourage recycling behavior.

### BRIEF DESCRIPTION OF THE SEVERAL VIEWS OF THE DRAWING

FIG. 1 illustrates an exemplary recycling bin that has been retrofitted with an embodiment of a smart recycling system.

FIG. 2 is a functional block diagram of an exemplary, non-limiting aspect of a smart recycling system in the form of a package for retrofitting to an existing collection bin.

FIG. 3 is a functional block diagram of a networked environment in which a given embodiment of a smart recycling system may operate.

### SUMMARY OF THE DISCLOSURE

Various embodiments, aspects and features of the present invention encompass a smart recycling system (“SRS”) configured for retrofit to a recycling bin. An exemplary embodiment includes a housing that is suitable for mounting to a recycling bin or a recycling bin lid. The housing may include an integrated circuit in communication with other components of the SRS such as photoelectric sensors positioned to recognize deposit of an item into the recycling bin. When the sensor is triggered by the deposit of the item, a signal indicative of that recycling event is generated and data associated with the recycling event is stored. In some embodiments, a positive feedback in the form of a “smiley face,” for instance, may be rendered on a display component for the benefit of the user and in response to the recycling event. Certain embodiments may also include functionality for rendering negative feedback in the event that a recycling event does not include the deposit of a recyclable but, rather, the deposit of a non-recyclable. Also, it is envisioned that one or more SRS embodiments may be networked to a central server for monitoring and analyzing data collected by, and associated with, each SRS.

It is an advantage of certain embodiments of an SRS that the SRS may be retrofitted to existing recycling systems that consist primarily of basic recycling receptacles in the form of a bin with or without a lid. It is a further advantage that some embodiments of an SRS may be operable to intermittently power one or more components within the system so that power consumption is minimized without significant risk of not recording a recycling event. It is a further advantage of some embodiments that signals generated by sensors may be parsed to recognize deposit of recyclables as opposed to deposit of non-recyclables or false positive events (e.g., a hand inserted to trip the sensor).

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “recyclable(s),” when used in a noun form, refers to any object that is constructed from one or more recyclable materials and is the subject of a given recycling program that deploys an embodiment of the solution disclosed herein. Conversely, the term “non-recyclable,” when used in a noun form, refers to any object or trigger other than a recyclable.

In this description, the term “application” refers generally to a logical algorithm used by a smart recycling system and may include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” “processing component” and the like are intended to refer to a computer-related entity, either hardware, firmware, a combination of hardware and software, software, or software in execution and represent exemplary means for providing the functionality and performing the certain steps in the processes or process flows described in this specification. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Further to that which is defined above, a “processing component” may be, but is not limited to, a central processing unit, a graphical processing unit, an analog processing unit, a core, a main core, a sub-core, a processing area, a hardware engine, etc. or any component residing within, or external to, an integrated circuit within a smart recycling system.

In this description, the terms “recycling bin,” “recycling receptacle,” “collection bin,” “disposal bin,” “trash receptacle,” “trash bin,” “bin,” and “receptacle” are used interchangeably and refer generally to any container suitable for receipt of objects such as, but not limited to, recyclables.

In this description, the term “user,” unless stated otherwise, refers to a person who is using, or is targeted for using, a smart recycling system through deposit of a recyclable or other object into a collection bin.

Notably, in this description, various embodiments of the solution are described within the context of a recycling program. Describing the solution within the context of a recycling program is offered for illustrative purposes only and is not meant to suggest that embodiments of the solution are limited to application within a recycling program. That is, it is envisioned that embodiments of the solution may be utilized in any number of scenarios including, but not limited to, trash deposits into bins (whether such trash is recyclable or not), donation deposits into collection bins (e.g., clothing deposits, canned food deposits, etc.), etc. Consequently, use of terms such as “recycling event” and its equivalents will be understood to include any deposit event into a collection bin outfitted with an embodiment of the solution and, as such, in no way limits the embodiments to monitoring, measuring and reporting only deposits of recyclables.

Embodiments of a smart recycling system (“SRS”) are envisioned to be retrofitted to existing collection bins for the purpose of monitoring recycling activity and collecting associated data. Some embodiments of an SRS may include a bin “top” or lid with integrated sensors and electronics while other embodiments may be configured for interfacing with an existing bin lid or an open top bin.

Further, certain embodiments may also include a feedback module for presenting a user with a feedback that either encourages, or discourages, recycling related behavior. For example, it is envisioned that some embodiments of an SRS may include a feedback module that displays a “smiley face” or other positive reinforcement feedback when a user deposits a recyclable into an associated receptacle. Moreover, some embodiments of an SRS may include a feedback module that displays a “frown face” or other negative feedback when a user deposits a non-recyclable into an associated bin or attempts to “trick” the SRS into logging a false positive event.

Certain embodiments of an SRS may be housed within a casing component that can be mechanically attached to an existing recycling bin. In this way, as one of ordinary skill in the art would recognize, an SRS may be retrofitted to existing recycling bins, regardless of their particular form, such that the expense for migration from a basic recycling system to a smart recycling system is mitigated. Depending on the embodiment, the casing component may be mechanically coupled to a bin lid such that a feedback display is viewable by a user, although such is not required in all embodiments. That is, it is also envisioned that certain embodiments of an SRS may be primarily used for activity monitoring and data collection and, as such, may not include a feedback display. Embodiments used for activity monitoring and data collection without providing feedback to a user at the point of recycling may be mounted underneath a bin lid or within a receptacle.

An SRS may monitor recycling behavior by recognizing signals generated by a sensor such as, but not limited to, a photoelectric sensor. Each time the photoelectric sensor is “tripped,” an SRS may determine that a recyclable has been deposited into the associated bin. Moreover, depending on the particular characteristics of the signal generated by the sensor, it is envisioned that some embodiments of an SRS may be able to determine that a given sensor trip event is representative of a false positive instead of a recyclable deposit. For instance, because a user inserting his hand into the SRS will inevitably cause the sensor to generate an analog signal having a signature that differs temporally from a comparative signal generated from deposit of a recyclable (such as an aluminum can), it is envisioned that certain SRS embodiments may be able to differentiate the receipt of a recyclable from a non-recyclable.

The use of photoelectric sensors is offered for exemplary purposes and is not meant to limit the scope of an SRS to include only photoelectric sensors. Notably, any sensor type suitable for recognizing the deposit of a recyclable and/or non-recyclable into a bin retrofitted with an SRS is envisioned by the present disclosure.

As one of ordinary skill in the art would understand, a photoelectric sensor (a.k.a. “photo eye”) may be used to detect the distance, absence or presence of an object by leveraging a light transmitter in conjunction with a photoelectric receiver. Depending on the particular type of photoelectric sensor being deployed by an SRS, triggering the sensor to generate a signal may be accomplished by “breaking” a light beam generated by the transmitter and monitored by the receiver. As would be understood by one of ordinary skill in the art, other embodiments of a photoelectric sensor may be triggered based on the receiver recognizing light generated by the transmitter and bounced off of a recyclable.

It is further envisioned that certain embodiments of an SRS may be designed within overall power constraints such that a net environmental benefit is optimized. For instance, the particular design of an SRS embodiment, including selection of components and/or modules, may be driven by a comparison of the energy needed to power the given SRS embodiment compared to an amount of energy saved as a result of user deposit of recyclables. Further, with a net environmental benefit in mind, it is envisioned that certain embodiments of an SRS may be designed such that a display module and/or sensor and/or other power consuming component within an SRS is intermittently powered. Advantageously, by cycling a power source at a given on/off rate, the overall power consumption of an SRS may be minimized without risk of failing to recognize the deposit of a recyclable. Additionally, it is envisioned that certain embodiments of an SRS may be powered by a solar cell module for charging a battery component within the SRS.

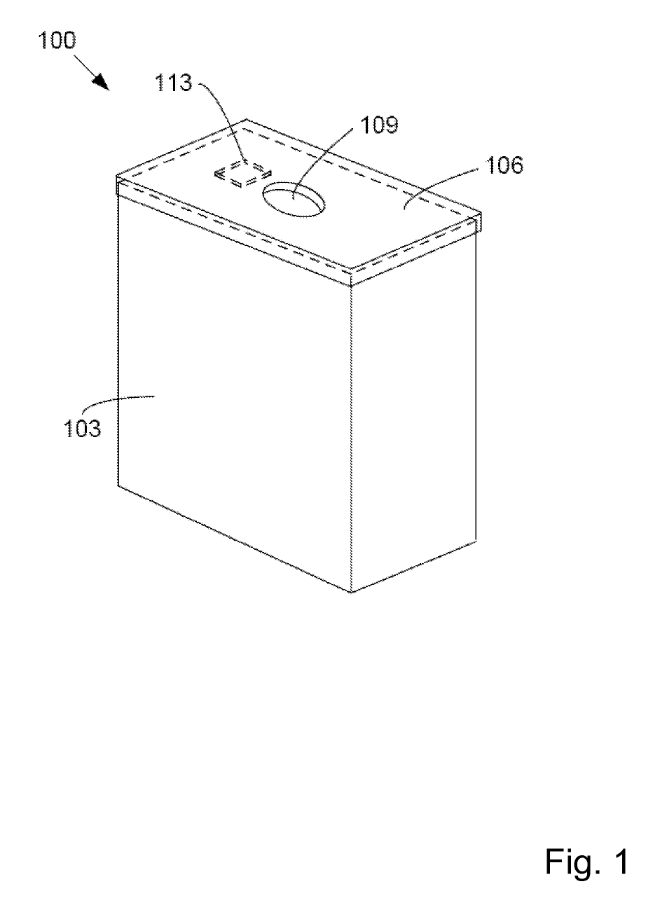

Referring to FIG. 1, an exemplary recycling bin 100 that has been retrofitted with an embodiment of a smart recycling system 113 is illustrated. The disposal bin 100 is configured to receive and store discarded items (not shown) such as cans, bottles, paper, etc. The items may or may not be recyclable according to various embodiments. The disposal bin 100 may include, for example, a receptacle body 103, a cover or lid 106, an opening 109, a smart recycling system (“SRS”) 113, as well as other components.

The opening 109 is a portion of the disposal bin 100 through which items pass when being deposited into the disposal bin 100. In some embodiments, the opening 109 may be omitted, and the items may be deposited into the disposal bin 100 by, for example, opening the lid 106. Additionally, the opening 109 in some embodiments may be located in other components of the disposal bin 100, such as the container body 103, for example.

The SRS 113 is shown in the FIG. 1 illustration as being deposited beneath the lid 106, however, it is envisioned that some embodiments of an SRS 113 may be retrofitted to the topside of lid 106 or to a portion of the bin 103. It is further envisioned that in some embodiments, certain components within SRS 113 may be external to lid 106 and bin 103 so that a user may interface with those components (e.g., a display or sound emitting device).

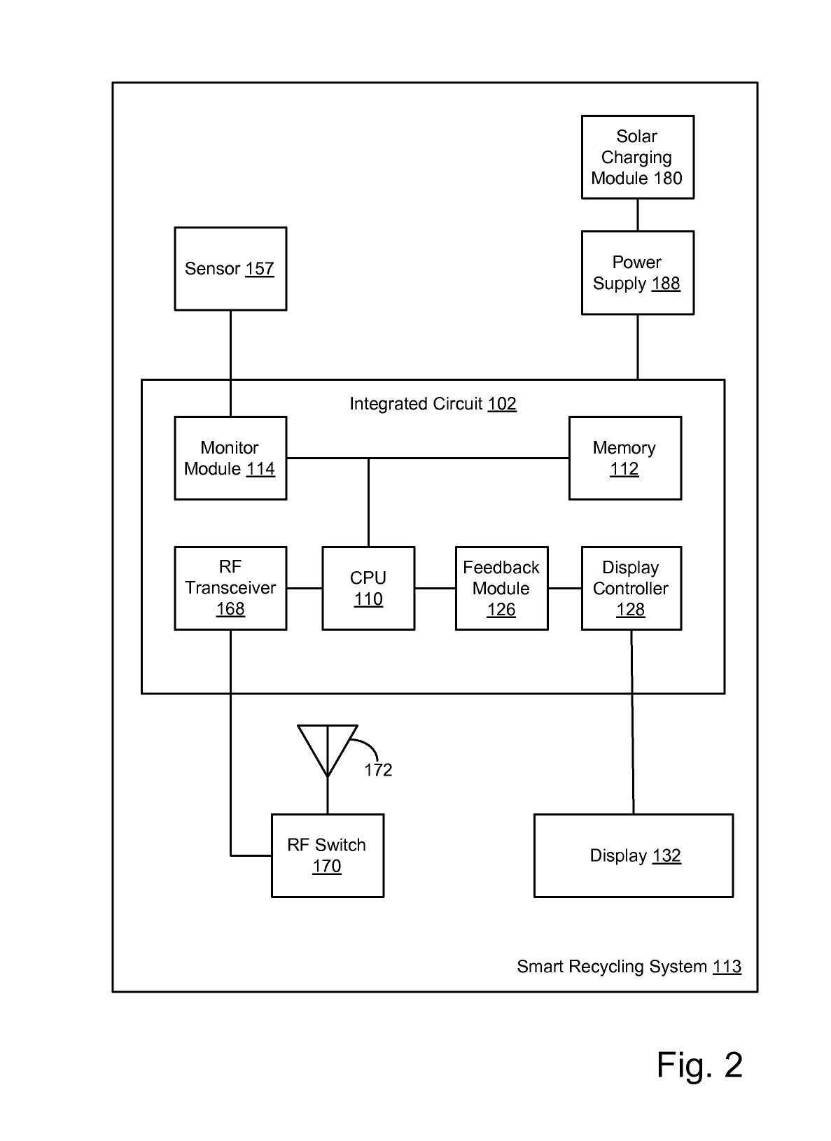

FIG. 2 is a functional block diagram of an exemplary, non-limiting aspect of a smart recycling system (“SRS”) 113 in the form of a package for retrofitting to an existing collection bin. As shown, the SRS 113 includes an on-chip system 102 that includes a processing component in the form of a central processing unit (“CPU”) 110 which may also include a coupled analog signal processor, as would be understood by one of ordinary skill in the art. The CPU 110 may comprise one or more cores, as would also be understood by one of ordinary skill in the art. Further, instead of a CPU 110, a digital signal processor (“DSP”) may also be employed as understood by one of ordinary skill in the art.

The monitor module 114 communicates with one or more sensors 157 and with the CPU 110. A feedback module 126 may also be in communication with the CPU 110 and a display controller 128 that is coupled to a display component 132. Notably, in this description, the display component 132 is meant to encompass any component for rendering a feedback to a user such as, but not limited to, a visual feedback, an audible feedback, etc. A memory 112 may also be coupled to the CPU 110. FIG. 2 further indicates that a radio frequency (“RF”) transceiver 168 may be coupled to the CPU 110. An RF switch 170 may be coupled to the RF transceiver 168 and an RF antenna 172. FIG. 2 also shows that a power supply 188, for example a battery, is coupled to the on-chip system 102 for providing power to the system 102. In a particular aspect, the power supply 188 includes a rechargeable DC battery or a DC power supply that is derived from an alternating current (“AC”) to DC transformer that is connected to an AC power source. In another particular aspect, the power supply 188 includes a rechargeable DC battery or DC power supply that is connected to a solar charging module 180 for converting and storing solar energy, as would be understood by one of ordinary skill in the art.

In operation, the SRS 113 is coupled to a recycling bin, such as bin 103 of FIG. 1, so that objects deposited in the bin 103 through a portal 109 may be monitored. The sensors 157 may include photoelectric sensors as described above that are physically positioned to recognize deposit of an object, such as a recyclable, through portal 109. It is also envisioned that the sensors 157 may include ultrasonic sensors or other sensors for recognizing a volume of objects that have been deposited into the bin 103.

The sensors 157 may generate a signal, as is understood by one of ordinary skill in the art, which is monitored by a monitor module 114. From the signal, the monitor module 114 may be able to determine that a recyclable has been deposited through the portal 109 and into the bin 103. In this way, the monitor module 114 may be able to collect data representative of recycling activity and store the data in a memory component 112. The CPU 110 may work with the feedback module 126 in some embodiments to cause a display controller 128 to render feedback to a user via display 132. Notably, it is envisioned that display 132 may include any means for rendering feedback triggered by a recycling event including, but not limited to, a “smiley face,” an incremented counter, a sound, etc.

In certain embodiments, the CPU 110 may be configured to intermittently power one or more of the components within SRS 113. For instance, to minimize power consumption by the SRS 113, the CPU 110 may intermittently power monitor module 114 and/or sensor 157 at a rate that reduces power consumption by those components yet guarantees that a recycling event will be recognized. As another example, in an embodiment of an SRS 113 where the sensors 157 include an ultrasonic sensor for measuring the level of recyclables deposited in bin 103, the CPU 110, executing intermittent power instructions stored in memory 112, may only periodically (e.g., once daily) power the ultrasonic sensor for capturing a level measurement. As another example, a photoelectric sensor for recognizing the deposit of a recyclable (or non-recyclable) through portal 109 may be powered intermittently (e.g., on/off every few milliseconds) to reduce the overall power consumption associated with the sensor without risking that a recycling event (e.g., deposit of a recyclable or non-recyclable) is missed by the monitoring module 114.

In a particular aspect, one or more of the method steps described herein may be implemented by executable instructions and parameters stored in the memory 112. These instructions may be executed by the CPU 110 or another processor to perform the methods described herein. Further, the processor 110, the memory 112, the instructions stored therein, or a combination thereof may serve as a means for performing one or more of the method steps described herein.

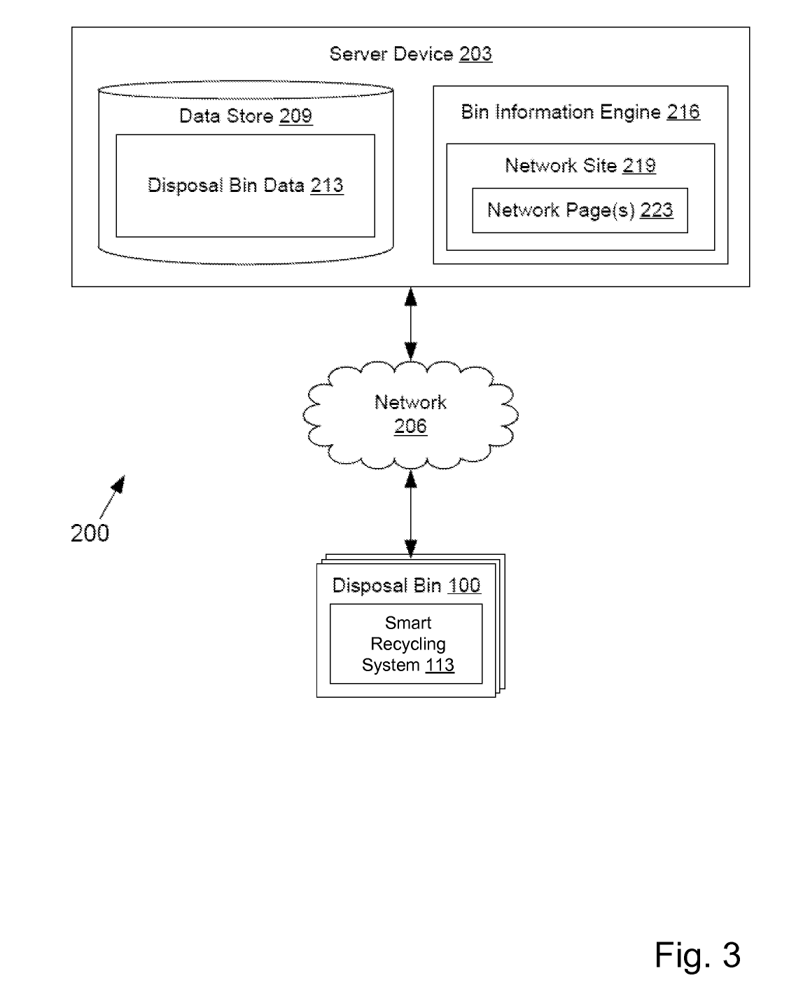

FIG. 3 is a functional block diagram of a networked environment 200 in which a given embodiment of a smart recycling system 113 may operate. The networked environment 200 may include multiple disposal bins 100 and a server device 203 in communication through a network 206. The network 206 may include, for example, the Internet, intranets, extranets, wide area networks (“WANs”), local area networks (“LANs”), wired networks, wireless networks, other suitable networks, or any combination thereof

The server device 203 may comprise, for example, a server computer or any other system providing computing capability. Alternatively, multiple server devices 203 may be employed that are arranged, for example, in one or more server banks or computer banks of other arrangements. For example, multiple server devices 203 together may comprise a cloud computing resource, a grid computing resource, and/or any other distributed computing arrangement. Such server devices 203 may be located in a single installation or may be distributed among many different geographical locations. For purposes of convenience, the server devices 203 are referred to herein in the singular. Even though the server devices 203 are referred to in the insular, it is understood that multiple server devices 203 may be employed in various arrangements.

Various applications and/or other functionality may be executed in the server device 203 according to various embodiments. Also, various data is stored in a data store 209 that is accessible to the server device 203. The data store 209 may be representative of a plurality of data stores as can be appreciate, including data stores in memory 112 of an SRS 113. The data stored in the data store 209 for example, is associated with the operation of the various applications and/or functional entities associated with the present disclosure. For instance, the data stored in the data store 209 may include disposal bin data 213 obtained from the SRS 113 via RF transceiver 168. Such data may include, for example, the quantity of items collected in each disposal bin 100 and various statistics or other information associated with the disposal bin 100. Furthermore, the disposal bin data 213 may be updated from time to time.

The server devices 203 may also include a bin information engine 216 that processes the various information associated with the disposal bin data 213. For instance, the bine information engine 216 may determine rankings and possibly other information for the disposal bins 100 in terms of items collected.

Additionally, the bin information engine 216 may generate a network site 219 to provide a network presence for the bin information engine 216. To this end, the network site 219 may include a network page server to serve data such as network pages 223 to clients (not shown) over a protocol such as hypertext transfer protocol (“HTTP”), simple object access protocol (“SOAP”), and/or other protocols as would occur to one of ordinary skill in the art. Such a network page server may comprise a commercially available network page server such as, for example, Apache ® HTTP Server, Microsoft ® Internet Information Services (“IIS”), and/or other network page servers.

The network site 219 may encode for display one or more network pages 223 that present information associated with the disposal bin data 213. Thus, users may be able to access the disposal bin data 213 through the network 206 and view data associated with the disposal bins 100. For instance, such a network page 223 may show the rankings of the disposal bins 100 in terms of items collected, volume of items collected, number of false positive recycling events, number of non-recyclables collected, timing of recycling events, etc.

Certain steps in the processes or process flows described in this specification naturally precede others for the invention to function as described. However, a smart recycling system that falls within the scope of this disclosure is not limited to functioning according to the order of the steps described if such order or sequence does not alter the functionality of an SRS. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the Figures and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a processing component.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Therefore, although selected aspects have been illustrated and described in detail, it will be understood that various substitutions and alterations may be made therein without departing from the spirit and scope of the present invention, as defined by the following claims.

What is claimed is:

1. A smart recycling system (“SRS”) for retrofit to a recycling bin, the SRS comprising:
a housing component for mounting to the recycling bin;
one or more sensors for generating a signal triggered by a recycling event, wherein a recycling event comprises deposit of an item into the recycling bin;
a monitor module in communication with the one or more sensors and configured to recognize a signal generated by the one or more sensors; and
a processing component for:
receiving notification from the monitor module that a recycling event has occurred;
storing data representative of the recycling event in a memory component; and
rendering a feedback via display component, wherein the feedback is associated with a particular recycling event.

2. The smart recycling system of claim 1, wherein the one or more sensors comprises a photoelectric sensor.

3. The smart recycling system of claim 2, wherein the monitor module is further configured to distinguish a signal from the photoelectric sensor triggered by a recycling event associated with a recyclable item from a signal from the photoelectric sensor triggered by a recycling event associated with a non-recyclable item.

4. The smart recycling system of claim 1, wherein the one or more sensors comprises an ultrasonic sensor.

5. The smart recycling system of claim 4, wherein the ultrasonic sensor is configured to generate a signal associated with a level of objects deposited in the recycling bin.

6. The smart recycling system of claim 1, wherein the rendered feedback is visual and depicts a smiley face.

7. The smart recycling system of claim 1, wherein the rendered feedback is audible.

8. The smart recycling system of claim 1, wherein the rendered feedback is in the form of an incremented counter.

9. The smart recycling system of claim 1, further comprising a radio frequency transceiver configured to communicate to a remote server.

10. The smart recycling system of claim 9, further configured to transmit the data associated with a recycling event to the remote server.

11. The smart recycling system of claim 1, wherein the processor is further configured to cause one or more of the sensors and monitoring module to be intermittently powered.

12. The smart recycling system of claim 1, further comprising a power source in the form of a direct current (“DC”) battery.

13. The smart recycling system of claim 12, wherein the power source is rechargeable.

14. The smart recycling system of claim 13, further comprising a solar charging module for recharging the power source.
